(19) United States
(12) Patent Application Publication
(10) Pub. No.: US 2018/0189750 A1
(43) Pub. Date: Jul. 5, 2018

(54) MAINTENANCE PLAN DRAFTING SUPPORT SYSTEM, METHOD, AND PROGRAM

(71) Applicant: FUJIFILM Corporation, Tokyo (JP)

(72) Inventors: Shunichiro NONAKA, Tokyo (JP); Masayuki NEGORO, Tokyo (JP); Satoshi KUBOTA, Tokyo (JP)

(73) Assignee: FUJIFILM Corporation, Tokyo (JP)

(21) Appl. No.: 15/909,185

(22) Filed: Mar. 1, 2018

Related U.S. Application Data
(63) Continuation of application No. PCT/JP2016/059666, filed on Mar. 25, 2016.

(30) Foreign Application Priority Data
Sep. 25, 2015 (JP) 2015-188535

(51) Int. Cl. G06Q 10/00; G06T 7/00; E01D 22/00

(52) U.S. Cl. CPC G06Q 10/20; G06T 2207/30184; E01D 22/00; G06T 7/0004

(57) ABSTRACT

An input unit (14) receives an input of structural object specification information of a structural object which is a drafting target of a maintenance plan, and a data input and output unit (16) acquires inspection result data (current data) including positional information and an image of a structural object corresponding to the structural object specification information from a data storage unit (50). A captured image analysis unit (18) analyzes an image included in the current data, and detects a damaged portion of the structural object. A priority level calculation unit (20) calculates a damage level based on a degree of damage of each damaged portion, predicts a future damage progression by referring to damage history data from the positional information of each damaged portion, and determines maintenance priority level by using the damage level and the prediction result of the future damage progression. A data processing unit (22) outputs a maintenance plan including the maintenance priority level on a display unit (24).

### CROSS-REFERENCE TO RELATED APPLICATIONS

This application is a Continuation of PCT International Application No. PCT/JP2016/059666 filed on Mar. 25, 2016, which claims priority under 35 U.S.C § 119(a) to Patent Application No. 2015-0188535 filed in Japan on Sep. 25, 2015, all of which are hereby expressly incorporated by reference into the present application.

### BACKGROUND OF THE INVENTION

### 1. Field of the Invention

The present invention relates to maintenance plan drafting support system, method, and non-transitory computer readable recording medium storing program, and particularly, to maintenance plan drafting support system, method, and non-transitory computer readable recording medium storing program for supporting maintenance plan drafting of a structural object such as a bridge.

### 2. Description of the Related Art

JP 2002-288270A discloses a repair and mending plan setting support system of a housing complex in which a captured image is compared with an image as an index, only a portion different from a portion in a previous image is extracted in image data, and the extracted portion is used as inspection image data (paragraphs <0046> to <0050>).

JP 2007-140608A discloses a structural object repairing plan support system that drafts a repair service plan of a civil engineering structural object in which in a case where there are inspection result data items at multiple points of time before and after the repair service, a repair effect is corrected by acquiring a degree of degradation and a change in degree of degradation per unit time before and after the repair service, that is, a degradation rate and adding the product of the degradation rate before and after the repair service and an elapsed time (paragraph <0066>).

### SUMMARY OF THE INVENTION

The system described in JP 2002-288270A extracts only the portion different from that of the previous image in the image data, and is able to reflect the influence of the change of the inspection portion with time on the maintenance plan with consideration for the influence of the change of the inspection portion with time on another portion of the structural object of the inspection target. The system described in JP 2007-140608A corrects the repair effect by using the change (degradation rate) in degree of degradation per unit time, and is not able to reflect the influence on the maintenance plan with consideration for the influence of the change of the inspection portion with time on another portion of the structural object of the inspection target.

The present invention has been made in view of such circumstances, and an object of the present invention is to provide maintenance plan drafting support system, method, and non-transitory computer readable recording medium storing program capable of reflecting influence of a change of an inspection portion of a structural object with time on the structural object in a case where a maintenance plan of the structural object is drafted.

In order to solve the problems, a maintenance plan drafting support system according to a first aspect of the present invention comprises inspection result input unit that receives inputs of inspection results at multiple past points of time which include image information items including images of inspection target portions of the structural object and positional information items of the inspection target portions, generation unit that performs time-series comparison on the inspection results at the multiple points of time, and generating the maintenance plan based on the result of the time-series comparison, and output unit that outputs the maintenance plan generated by the generation unit.

According to the first aspect, a change of the damaged portion detected in the target structural object with time is evaluated, and thus, a re-inspection or a repair priority level may be set. Accordingly, it is possible to support the drafting of the maintenance plan on which the influence of the change of the inspection portion of the structural object with time on the structural object is reflected.

According to a maintenance plan drafting support system according to a second aspect of the present invention, in the first aspect, the generation unit predicts a progression of damage based on a degree of the damage changing with time for a predetermined past period, which is included in the inspection target portion, and a most recent inspection result of the damage from the inspection results at the multiple past points of time, and generates the maintenance plan based on the prediction result of the progression of the damage.

According to a maintenance plan drafting support system according to a third aspect of the present invention, in the second aspect, the generation unit gives a high maintenance priority to a portion in which it is predicted that the progression of the damage is to be rapid.

According to a maintenance plan drafting support system according to a fourth aspect of the present invention, in the second or third aspect, the maintenance plan drafting support system further comprises preferential inspection portion information acquisition unit that acquires preferential inspection portion information indicating a preferential inspection portion of the structural object to which a high maintenance priority is given. The generation unit estimates a progression direction and a progression rate of the damage based on the prediction result of the progression of the damage, and generates the maintenance plan based on a relationship between the estimation result of the progression direction and the progression rate of the damage and the preferential inspection portion in addition to the result of the time-series comparison.

According to a maintenance plan drafting support system according to a fifth aspect of the present invention, in the fourth aspect, the maintenance plan drafting support system further comprises preferential inspection portion specification unit that generates the preferential inspection portion information by specifying the preferential inspection portion of the inspection target portions of the structural object based on at least one information of information regarding importance of the inspection target portion in terms of structure, design information of the inspection target portion, or environment information in which the inspection target portion is positioned.

According to a maintenance plan drafting support system according to a sixth aspect of the present invention, in the first to fifth aspects, the maintenance plan drafting support system further comprises plan input unit that receives an input of at least one plan of an inspection plan or a repair plan of the structural object. The generation unit generates the maintenance plan based on the plan received by the plan input unit in addition to the result of the time-series comparison.

According to a maintenance plan drafting support system according to a seventh aspect of the present invention, in the sixth aspect, the plan input unit receives an input of an inspection timing determined for the structural object, and the generation unit matches an inspection or repair timing of the structural object with the inspection timing based on the maintenance plan.

According to the sixth and seventh aspects, it is possible to perform inspection so as to match with an inspection timing set by another system. Accordingly, it is possible to draft an efficient maintenance plan.

According to a maintenance plan drafting support system according to an eighth aspect of the present invention, in the first to seventh aspects, the generation unit performs cost estimation of the maintenance plan, and generates the maintenance plan based on the result of the cost estimation in addition to the result of the time-series comparison.

According to a maintenance plan drafting support system according to a ninth aspect of the present invention, in the first to eighth aspects, the maintenance plan drafting support system further comprises repair result input unit that receives inputs of repair results indicating results acquired by repairing the inspection target portions at the multiple past points of time. The generation unit performs the time-series comparison on the repair results at the multiple points of time, and generates the maintenance plan.

According to a maintenance plan drafting support system according to a tenth aspect of the present invention, in the first to ninth aspects, the generation unit changes a time taken to perform next maintenance or changes an inspection item in the next maintenance in a case where an evaluation value of the structural object in a most recent inspection result is equal to or greater than a threshold value.

According to a maintenance plan drafting support system according to an eleventh aspect of the present invention, in the first to tenth aspects, the generation unit generates the maintenance plan at predetermined time intervals.

A maintenance plan drafting support method according to a twelfth aspect of the present invention comprises receiving inputs of inspection results at multiple past points of time which include image information items including images of inspection target portions of the structural object and positional information items of the inspection target portions, performing time-series comparison on the inspection results at the multiple points of time, and generating the maintenance plan based on the result of the time-series comparison, and outputting the generated maintenance plan.

A non-transitory computer readable recording medium storing a maintenance plan drafting support program according to a thirteenth aspect of the present invention which causes a computer to realize an inspection result inputting function of receiving inputs of inspection results at multiple past points of time which include image information items including images of inspection target portions of the structural object and positional information items of the inspection target portions, a generation function of performing time-series comparison on the inspection results at the multiple points of time, and generating the maintenance plan based on the result of the time-series comparison, and an outputting function of outputting the generated maintenance plan.

According to the present invention, a change of the damaged portion detected in the target structural object with time is evaluated, and thus, a re-inspection or a repair priority level may be set. Accordingly, it is possible to support the drafting of the maintenance plan on which the influence of the change of the inspection portion of the structural object with time on the structural object is reflected.

### BRIEF DESCRIPTION OF THE DRAWINGS

FIG. 1 is a block diagram showing a configuration of a maintenance plan drafting support system according to an embodiment of the present invention.

FIG. 2 is a block diagram showing a configuration of an inspection device according to the embodiment of the present invention.

FIG. 3 is a perspective view showing an example of attachment and operation methods of an inspection camera in a case where a target structural object is a bridge.

FIG. 4 is a flowchart showing a process of a maintenance plan drafting support method according to the embodiment of the present invention.

FIG. 5 is a diagram showing an output example of a maintenance plan.

FIG. 6 is a diagram showing an output example of damage history data.

### DESCRIPTION OF THE PREFERRED EMBODIMENTS

Hereinafter, maintenance plan drafting support system, method, and program according to an embodiment of the present invention will be described with reference to the accompanying drawings.

[Configuration of Maintenance Plan Drafting Support System]

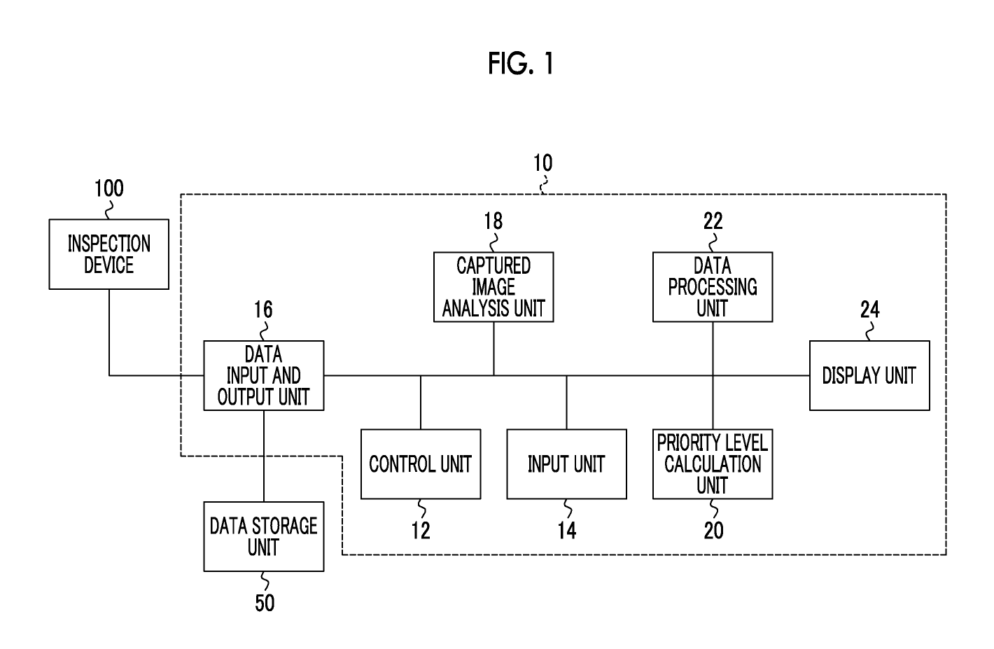

FIG. 1 is a block diagram showing a configuration of a maintenance plan drafting support system according to an embodiment of the present invention.

As shown in FIG. 1, a maintenance plan drafting support system 10 according to the present embodiment includes a control unit 12, an input unit 14, a data input and output unit 16, a captured image analysis unit 18, a data processing unit 22, a priority level calculation unit 20, and a display unit 24.

The control unit 12 includes a central processing unit (CPU) for controlling operations of the units of the maintenance plan drafting support system 10, a read only memory (ROM) that stores a control program, and a synchronous dynamic random access memory (SDRAM) capable of being used as a work area of the CPU. The control unit 12 receives an operation input of an operator through the input unit 14 (for example, operation input means such as a pointing device such as a keyboard, a mouse, or a touch panel), transmits a control signal corresponding to the operation input to the units of the maintenance plan drafting support system 10, and controls operations of the units.

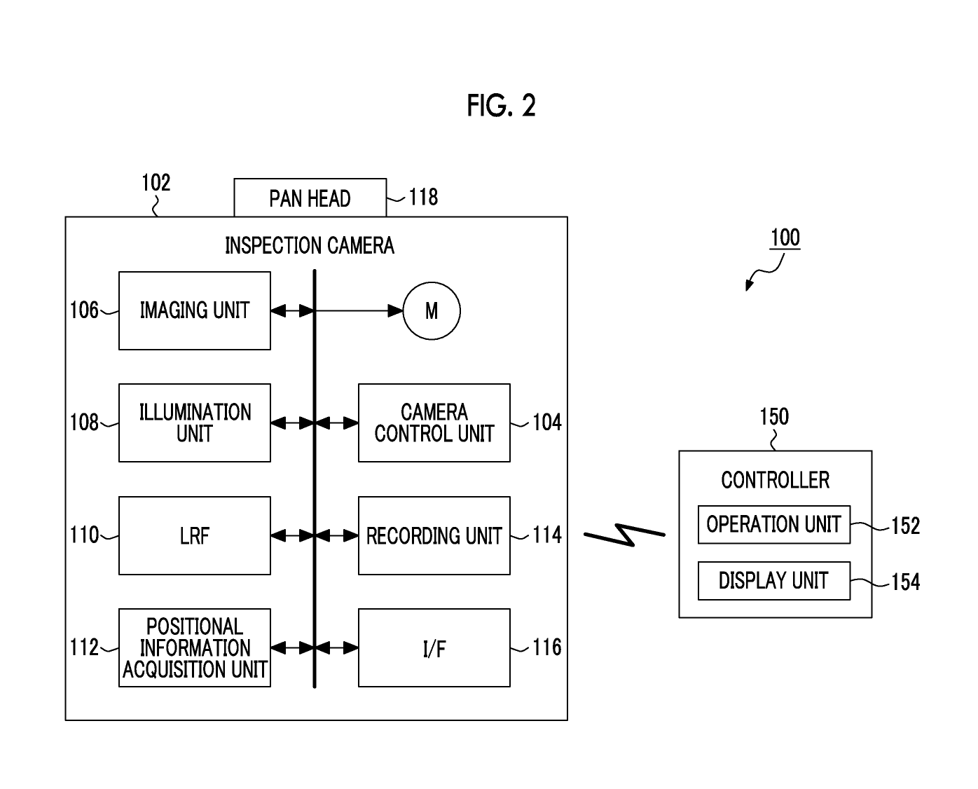

The maintenance plan drafting support system 10 is able to communicate with a data storage unit 50 and an inspection device 100 through a network such as the Internet. The maintenance plan drafting support system 10 may transmit inspection plan data (for example, an attachment position of the inspection camera 102 (see FIG. 2), designation of an attachment component and a tool, a movement route and control information (including a posture (an orientation and an angle) at the time of imaging) of the inspection camera 102, information for controlling zoom, an imaging target, and information regarding an inspection timing) to the inspection device 100 according to a request from the inspection device 100. For example, wired communication (for example, connection using a universal serial bus (USB) cable, a local area network (LAN), a wide area network (WAN), or Internet connection) or wireless communication (for example, LAN, WAN, Internet connection, Bluetooth (registered trademark), or infrared communication) may be used as a communication method between the maintenance plan drafting support system 10 and the data storage unit 50 and the inspection device 100.

The data storage unit 50 is a database that stores structural object information items (including information (structural object specification information) for specifying the structural object and data regarding inspection results and repair results at multiple past points of time) of a plurality of structural objects. Although it has been described in the present embodiment that the structural object information is stored in the data storage unit 50 different from the maintenance plan drafting support system 10, the data storage unit 50 may be provided in the maintenance plan drafting support system 10.

The data input and output unit 16 (inspection result input means) receives an input of inspection result data (hereinafter, referred to as current data) of the structural object (target structural object) which is an inspection target from the inspection device 100. The inspection result data includes structural object specification information for specifying the target structural object, image information including an image acquired by imaging the target structural object and information on an imaging date and time of the image, and positional information for specifying a position (coordinates) of the imaging target within the target structural object. It is preferable that the inspection result data is a most recent inspection result (a result having latest imaging date and time information) of the inspection results of the target structural object. The data input and output unit 16 outputs the current data input from the inspection device 100 to the data storage unit 50, and stores the current data in the data storage unit.

The data input and output unit 16 extracts the structural object information from the inspection result data input from the inspection device 100, and searches the data storage unit 50 by using the extracted structural object specification information. The data input and output unit 16 acquires the past inspection result data and the repair result data of the target structural object from the data storage unit 50.

The captured image analysis unit 18 performs image analysis on an image included in the inspection result data (current data) of the target structural object input from the inspection device 100, and detects a damaged portion from an image of an inspection target portion (inspection portion or a captured portion) of the target structural object. For example, a method of using the analysis result of the colors of the captured image may be used as the method of detecting the damage by performing the image analysis on the captured image. For example, a crack may be detected by the method described in JP5113810B and JP5384429 B, and rust may be detected by the method described in JP5427198 B and JP5605234 B.

The priority level calculation unit 20 (generation means, preferential inspection portion information acquisition means, or preferential inspection portion information specification means) calculates a damage level based on a degree of damage (for example, a width and a length of the crack, an area of a region (peeled region) in which the painting of the front surface is peeled off, or an area of the rust) in each damaged portion. The damage level is an indicator indicating the importance of the damage in each damaged portion, and may be automatically calculated depending on the degree of the damage or the operator may change the calculation result. The damage level may estimate a progression direction and a progression rate (progression situation: for example, an expansion direction and an expansion rate of crack, peeled region, rust region) of the damage based on the degree of damage and damage history data, and may raise an evaluation value of the damage level in a case where the progression rate is high as the estimation result. The damage level may be calculated by comprehensively evaluating the degree of the damage, the progression situation, and a relationship (a positional relationship with a vulnerable portion in terms of structure such as a joining or welding portion, a stress concentration portion, or a portion in which distortion is discovered, a distance, or whether or not there is another reinforcing member) with another constituent element of the target structural object in addition to the situation of the damaged portion.

The priority level calculation unit 20 specifies a position of each damaged portion within the target structural object from the positional information corresponding to the image from which each damaged portion is detected, and acquires the damage history data related to the damage discovered in the past in the position of the damaged portion from the past inspection result data and repair result data of the specified position of the damaged portion. For example, the damage history data includes data indicating a follow-up observation result in a case where the degree of damage discovered in the past inspection and the repair of the damage is postponed and data indicating a repair method and the follow-up observation result in a case where the repair of the damage is conducted. For example, the data indicating the follow-up observation result includes information (elapsed time information indicating a time elapsing after the damaged portion is discovered) indicating an inspection conduction date and time when the damaged portion is discovered and a next inspection conduction date and time, and a degree of expansion of the damage. The degree of expansion of the damage includes data indicating a difference (increase amount) in width and length of the crack in the case of the crack or a difference (expansion amount) in area in the case of the peeled region and the rust region.

In a case where the past damage history information is not included in the past inspection result data and repair result data, the past damage history information may be acquired by analyzing the image information included in the past inspection result data and repair result data by using the captured image analysis unit 18.

The priority level calculation unit 20 performs time-series comparison on the damage level of each damaged portion calculated from current data with the damage history data acquired from the past inspection result data and repair result data, predicts a future damage progression situation for each damaged portion, and determines a maintenance priority level (priority) based on the damage level of each damaged portion calculated from the current data and the prediction result of the damage. The priority level calculation unit 20 generates a maintenance plan of the target structural object based on the determination result of the maintenance priority level.

The data processing unit 22 processes data including the maintenance plan generated by the priority level calculation unit 20 into data in an output format, and outputs the processed data to the display unit 24.

As the output means of the maintenance plan, print mans for printing the maintenance plan in a predetermined format may be provided instead of the display unit 24 or in addition to the display unit 24.

[Configuration of Inspection Device]

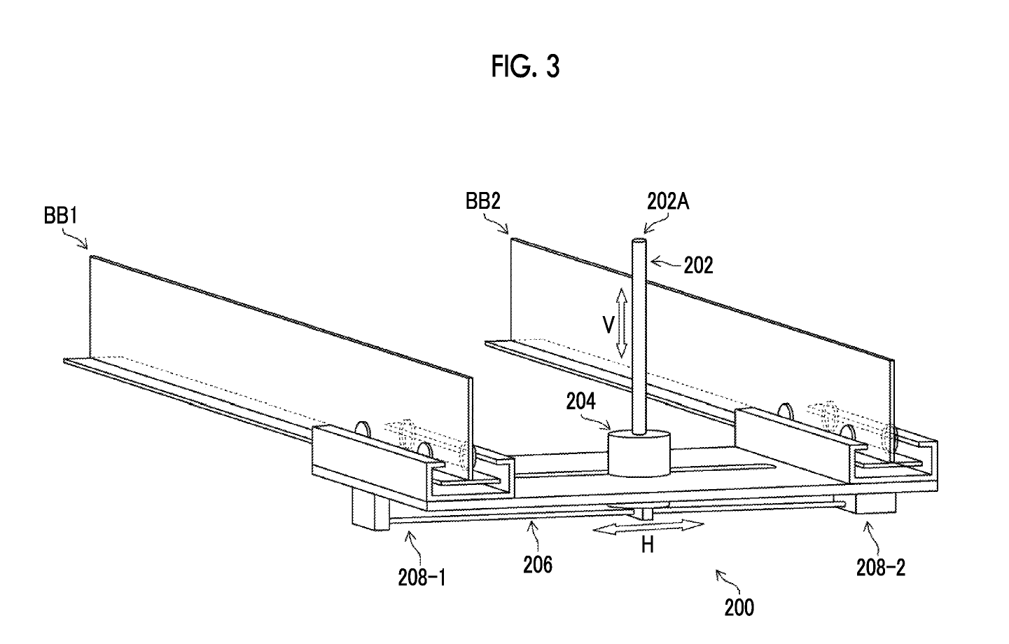

Next, an example of the inspection device 100 will be described with reference to FIGS. 2 and 3. FIG. 2 is a block diagram showing a configuration of the inspection device according to the embodiment of the present invention.

The inspection device 100 according to the present embodiment includes an inspection camera 102, and a controller 150. The inspection camera 102 includes a camera control unit 104, an imaging unit 106, an illumination unit 108, a laser range finder (LRF) 110, a positional information acquisition unit 112, a recording unit 114, and a communication interface (I/F) 116.

The camera control unit 104 includes a CPU that controls the operations of the units of the inspection camera 102, a ROM that stores a control program, and an SDRAM that is able to be used as a work area of the CPU. The camera control unit 104 receives an operation unit of the operator through the controller 150, transmits the control signal corresponding to the operation input to the units of the inspection camera 102 through a bus, and controls the operations of the units.

The controller 150 includes an operation unit 152 and a display unit 154. A tablet terminal that includes the display unit 154 (for example, liquid crystal display) for displaying an image captured by the inspection camera 102 and a graphical user interface (GUI) for operation and the operation unit 152 as a touch panel formed on a front surface of the display unit 154 may be used as the controller 150.

The communication interface (I/F) 116 is means for communicating with the controller 150. Wired communication (for example, connection using a USB cable, LAN, WAN, or Internet connection) or wireless communication (for example, LAN, WAN, Internet connection, Bluetooth (registered trademark), or infrared communication) may be used as a communication method between the inspection camera 102 and the controller 150.

The imaging unit 106 is means for imaging a subject (the inspection portion of the target structural object), and includes, for example, a zoom lens, a focus lens, a stop, and an imaging element. The imaging unit 106 images the inspection portion of the target structural object according to an operation input from the operation unit 152. An image (still image or a motion picture) captured by the imaging unit 106 is transmitted to the controller 150 through the I/F 116, and is displayed on the display unit 154. The captured image is recorded in the recording unit 114 (for example, a USB memory or a memory card) according to an operation input from the operation unit 152. The recording unit 114 may be provided at the controller 150, or may be provided at both the inspection camera 102 and the controller 150.

The illumination unit 108 is means for illuminating the subject, and includes, for example, light emitting diode (LED).

The LRF 110 includes a laser diode, and is a device that performs distance measurement from by a traveling time from when the subject is irradiated with a laser beam to when reflection light is reflected or projects a laser aiming point onto the subject. The operator moves a pan head 118 through the operation unit 152 by a motor M while checking the position or posture of the inspection camera 102 for the subject by checking the laser aiming point projected onto the subject on the display unit 154 of the controller 150. Thus, the operation can control the posture of the inspection camera 102. Distance information to the subject may be acquired by the LRF 110, or the distance information may be acquired by using a stereo camera as the imaging unit 106.

The positional information acquisition unit 112 acquires positional information (for example, global positioning system (GPS) information) of the inspection portion. The positional information of the inspection portion may be acquired by providing an integrated circuit (IC0 chip in which the positional information is stored in each inspection portion of the target structural object and performing communication between the inspection camera 102 and the IC chip.

FIG. 3 is a perspective view showing an example of attachment and operation methods of the inspection camera in a case where the target structural object is the bridge.

As shown in FIG. 3, an inspection camera attachment member 200 includes a pole 202, a camera installation portion 202A, a pole base portion 204, a rail 206, and attachment members 208-1 and 208-2.

The attachment members 208-1 and 208-2 are members for attaching the rail 206 and bridge girders BB1 and BB2 to the target structural object. The number or kind of attachment members 208-1 and 208-2 may be changed depending on the inspection portions of the target structural object, an interval between the bridge piers, and the number of bridge girders or bridge piers. Wheels (not shown) are attached to the attachment members 208-1 and 208-2, and the attachment members are movable along the bridge girders BB1 and BB2 according to an instruction input from the controller 150.

The pole 202 may expand and contract in a vertical direction (V direction) by being driven by a motor. The camera installation portion 202A for attaching the pan head 118 of the inspection camera 102 is formed at an upper end portion of the pole 202 in the diagram.

The pole base portion 204 is formed at a lower end portion of the pole 202, and the pole base portion 204 is attached to the rail 206. For example, the pole base portion 204 is movable in a horizontal direction (H direction) along the rail 206 by driving a ball screw by a motor (not shown).

According to an operation input from the controller 150, the operator may move the inspection camera 102 along the rail 206 and the bridge girders BB1 and BB2, may perform posture (orientation or tilt angle) control of the inspection camera 102 with respect to the structural object such as the bridge girder or the bridge pier, focus control, zoom control, or illumination control by the pan head 118, and may image steel members or concrete members constituting the bridge girder or the bridge pier. Accordingly, it is possible to acquire the captured image together with the positional information.

The method of performing the inspection by attaching the inspection camera 102 to a part of the structural object such as the bridge girder or the bridge pier is not limited to the example of FIG. 3. The shape of the rail, and the number or shapes of attachment members are determined depending on the arrangement and shape of bridge piers. A suspension type in which the inspection camera 102 is hung by the bridge girder through the pole or a high place installation type in which the inspection camera 102 is installation in a high place may be used.

The inspection camera 102 may be mounted on an unmanned aerial vehicle (for example, multicopter or drone), and the target structural object may be captured. In a case where the unmanned aerial vehicle is used, the positional information of the inspection portion may be acquired by providing the IC chip in which the positional information is stored in each inspection portion of the target structural object and performing the communication between the inspection camera 102 and the IC chip, or the GPS information may be used.

Although it has been described in the present embodiment that an inspection robot capable of imaging the inspection portion while moving the inspection camera 102 in a direction along the rail 206 and the bridge girders BB1 and BB2 according to an instruction input from the controller 150 is used after the inspection device 100 is attached to the structural object, the present invention is not limited thereto. For example, the operator (inspector) may perform the attachment of the inspection camera 102, an imaging operation, and an input of the positional information.

[Maintenance Plan Drafting Support Process]

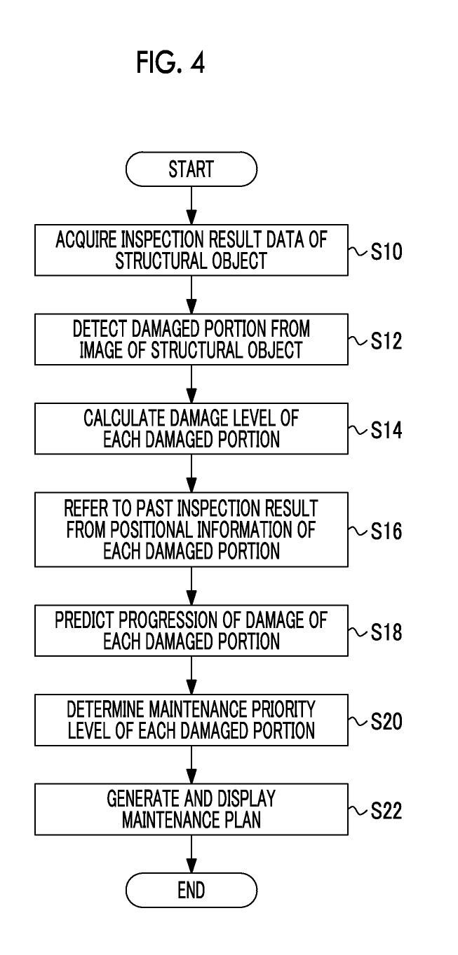

FIG. 4 is a flowchart showing a process of a maintenance plan drafting support method according to the embodiment of the present invention.

The inspection device 100 images the inspection portion of the target structural object, and inputs the inspection result data including the positional information and the image information including the captured image to the maintenance plan drafting support system 10 through the data input and output unit 16. The maintenance plan drafting support system 10 outputs and stores the inspection result data to and in the data storage unit 50 through the data input and output unit 16. By doing this, the inspection result data items regarding a plurality of target structural objects are accumulated in the data storage unit 50. The repair result data including information on the repair method and the repair timing is accumulated in the data storage unit 50. The maintenance plan drafting support system 10 may generate the inspection result data including the detection result of the damaged portion in addition to the captured image and the positional information by using the image analysis result using the captured image analysis unit 18, and may store the generated inspection result data in the data storage unit 50.

The maintenance plan drafting support system 10 receives an input of the structural object specification information (for example, identification number or a name (A Bridge) of the structural object) for specifying the structural object which is a drafting target of the maintenance plan by the input unit 14, and the data input and output unit 16 acquires the inspection result data (current data: for example, latest inspection result data) including the positional information and the image of the structural object corresponding to the received structural object specification information from the data storage unit 50 (step S10).

Subsequently, the captured image analysis unit 18 analyzes the image included in the inspection result data (current data) acquired in step S10, and detects the damaged portion of the structural object (step S12).

The priority level calculation unit 20 calculates the damage level of each damaged portion based on the degree of damage (for example, the width or length of the crack, the area of the peeled front surface, or the area of the rust region) of each damaged portion (step S14). The priority level calculation unit 20 refers to the damage history data such as the size of the past damage from the positional information of each damaged portion (step S16). The priority level calculation unit 20 predicts a future damage progression of the damaged portion detected from the current data (step S18). The priority level calculation unit 20 determines the maintenance priority level by using the prediction result of the future damage progression or the damage level (step S20).

The data processing unit 22 processes the maintenance plan including the maintenance priority level into display data, and outputs the processed data to the display unit 24 (step S22). Accordingly, the maintenance plan (maintenance priority level) is displayed on the display unit 24.

[Output Example]

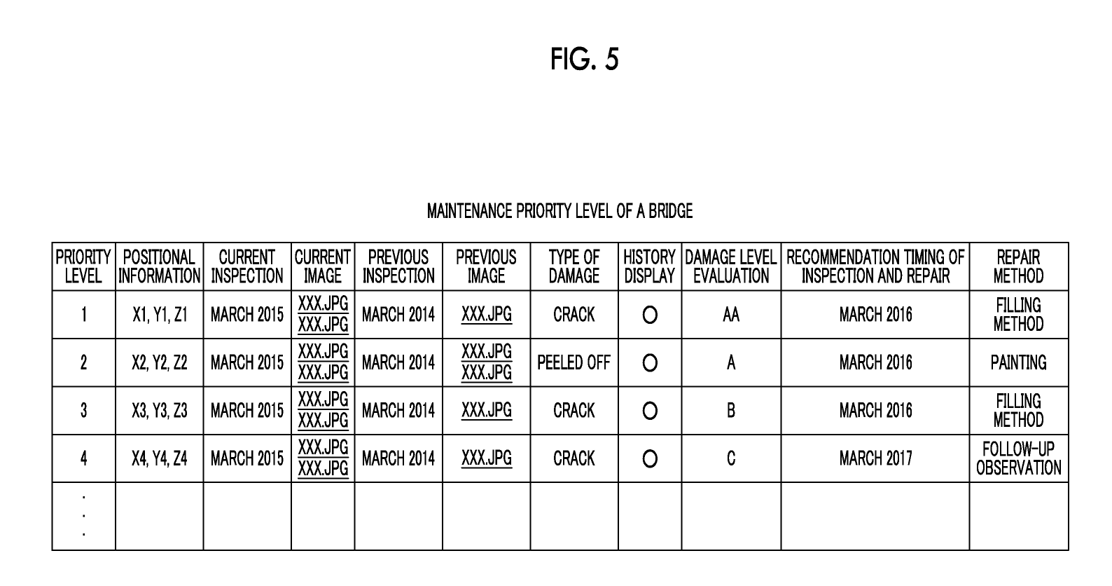

FIG. 5 is a diagram showing an output example of the maintenance plan.

In the example shown in FIG. 5, the damaged portion detected in the target structural object (A Bridge) is displayed by being specified by the positional information (three-dimensional coordinates of the target structural object. The damaged portions are displayed in order of the maintenance priority level.

In the example shown in FIG. 5, information indicating a current inspection timing and a previous inspection timing, links for displaying image files acquired in the current-stage inspection and the previous-stage inspection, the type (crack and/or peeling off) of the detected damage, an icon for displaying a damage history, an evaluation value (AA, A, B, C, . . . are displayed in descending order of the importance of the damage) of the damage level, a recommendation timing (a recommendation deadline when re-inspection or repair is conducted) of the inspection or repair, and a repair method to be recommended are described in order for every damaged portion.

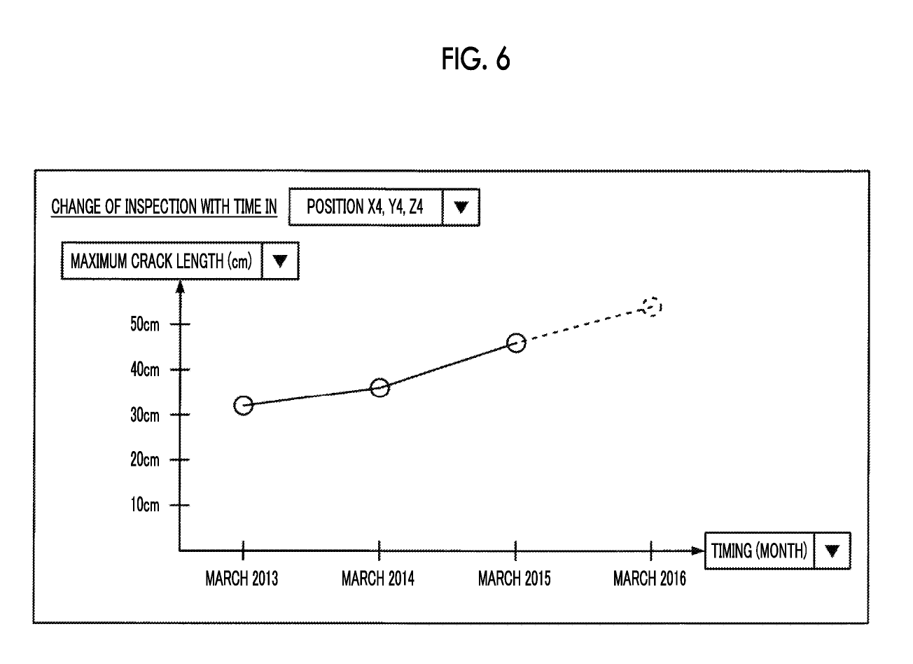

FIG. 6 is a diagram showing an output example of the damage history data. FIG. 6 shows a change in inspection result of a damaged portion (X4, Y4, Z4) having a fourth priority level with time.

A history display icon of the fourth priority level is selected on a screen of FIG. 5, and the screen may be changed to a screen of FIG. 6. The position of the damaged portion is selected by a pull-down menu of the position of the damaged portion of FIG. 6, and thus, the screen may be changed to a history screen of another damaged portion.

In the example shown in FIG. 6, a change in maximum crack length (a maximum value of a length of the crack of the crack portion) of the crack the damaged portion (X4, Y4, Z4) for every year is displayed. For example, an inspection conduction timing on a lateral axis of FIG. 6 may be changed, and may be yearly or daily changed. For example, a display item on a vertical axis may be changed, and may be changed to an average value of the width of the crack, an interval (average interval), an area (cm²) of the crack region, or an area (cm²) of the rust area.

In the example shown in FIG. 6, a result of a periodic inspection for every year is displayed, and a prediction value of the maximum length of the crack in a periodic inspection timing (March 2016) after latest (March 2015) inspection result data is displayed. In the example shown in FIG. 5, the follow-up observation is performed without performing the repair based on the prediction value, and a re-inspection timing is recommended. As stated above, the progression of the damage is predicted, and thus, it is possible to perform control such that a high damage level and a high maintenance priority level is given to a portion in which it is predicted that the progression of the damage is to be rapid.

In addition to FIG. 6, for example, the repair result data may be acquired from the data storage unit 50 through the data input and output unit 16 (repair result input means), the situation of the damaged portion after the repair is performed by the repair method may be predicted by using the repair result data, and the prediction result may be displayed. For example, after the repair is performed by using a filling method as the repair method in a case where the crack is detected in the damaged portion (X4, Y4, Z4), whether or not the crack occurs again and the progression situation after the re-occurrence may be displayed.

Although it has been described in the example shown in FIGS. 5 and 6 that the progression situation of the damage is displayed, the degree of damage, the progression situation (the expansion direction of the crack region, the peeled region, or the rust region), the relationship (the positional relationship with a vulnerable portion (a portion in which it is evaluated that inspection necessity (importance) is high) in terms of structure such as a joining or welding portion, a stress concentration portion, or a portion in which distortion is discovered, a distance, or whether or not there is another reinforcing member) with another constituent element of the target structural object may be displayed in addition to the situation of the damaged portion. These elements may be comprehensively evaluated.

The result of the comprehensive evaluation may be reflected on the damage level and the maintenance priority level. For example, even though it is evaluated that the length of the crack is short, the area of the peeled region is small, or the progression rate is slow, in a case where the damage progresses toward the portion (preferential inspection portion) in which it is evaluated that the inspection necessity (importance) is high, a calculation expression such that an evaluation value of the damage level and the maintenance priority level increases may be used. The preferential inspection portion information indicating the preferential inspection portion may be acquired from the data storage unit 50 through the data input and output unit 16. The preferential inspection portion may be specified by the priority level calculation unit 20 (preferential inspection portion specification means), the relationship with the progression direction of the damage may be evaluated, and the damage level and the maintenance priority level may be determined.

Design information of the structural object and environment information in which the structural object is positioned may be reflected on the damage level and the maintenance priority level. For example, the design information is information (rigid-frame bridge, suspension bridge, cable-stayed bridge, arch bridge, or movable bridge (drawbridge)) regarding a basic structure of the structural object, a material (steel, concrete, mortar, brick, or stone, or combinations thereof), information items (a material and/or a shape (a steel plate girder, a steel box girder, or a prestressed concrete (PC) box girder, or a material and/or a shape of a bridge pier) of a bridge girder) regarding the structures of the portions of the structural object, purpose of use (for example, for vehicles (the number of lanes), for person or motorcycles, or aqueduct). The environment is information indicating an environment of the inspection portion, and is, for example, a direction and/or an orientation or information indicating whether inspection portion faces or does not face the sea. For example, a calculation expression such that an evaluation value of the damage level and the maintenance priority level increases may be used for a portion made from a brittle material, a portion in which members made from different kinds of materials are connected to each other, a portion (a portion in which sea breeze brushes) facing the sea, or a portion in which the ground is weak of the structural object.

For example, a calculation expression such that an evaluation value of the damage level and the maintenance priority level increases based on the geographic information may be used for a portion in which rainfall is high or a structural object in which traffic is heavy.

The damage level and the maintenance priority level of a plurality of structural objects in the same district (for example, same municipality) in addition to one structural object may be evaluated, and drafting of a comprehensive maintenance plan related to the plurality of structural objects within the same district may be supported.

Cost estimation may be reflected on the damage level and the maintenance priority level. Cost information including the correspondence of a repair method to be recommended, a degree of damage, and cost required in the repair may be stored in the data storage unit 50, and the cost estimation corresponding to the repair method and the degree of damage of the current data may be acquired from the data storage unit 50 and may be output in a case where display data is generated by the data processing unit 22.

The inspection plan and the repair plan (for example, legal inspection related to the target structural object) previously planned for the target structural object may be received through the input unit 14 (plan input means), and the maintenance plan may be generated by determining a recommendation timing of the inspection and/or repair so as to match the scheduled timing of the inspection plan and the repair plan.

In a case where the evaluation value of the inspection portion of the structural object is large (in a case where the evaluation value is equal to or greater than a predetermined threshold value, that is, in a case where the evaluation value of the damage level and the maintenance priority level is small), a time taken to perform next maintenance may be changed (to be long), or an inspection item may be changed or reduced. The maintenance plan may be generated for every target structural object at predetermined time intervals.

According to the present embodiment, a change of the damaged portion detected in the target structural object with time is evaluated, and thus, a re-inspection or a repair priority level may be set. Accordingly, it is possible to support the drafting of the maintenance plan on which the influence of the change of the inspection portion of the structural object with time on the structural object is reflected.

The present invention may be realized as a program (maintenance plan drafting support program) causing a computer to realize the process or a non-transitory recording medium or a program product storing the program thereon.

### EXPLANATION OF REFERENCES

10: maintenance plan drafting support system
12: control unit
14: input unit
16: data input and output unit
18: captured image analysis unit
20: priority level calculation unit
22: data processing unit
24: display unit
50: data storage unit
100: inspection device

What is claimed is:

1. A maintenance plan drafting support system for supporting drafting of a maintenance plan of a structural object, the system comprising:
an inspection result input unit that receives inputs of inspection results data at multiple past points of time which include image information items including captured images of inspection target portions of the structural object and positional information items of the inspection target portions;
a captured image analysis unit that detects an damaged portion from images of inspection target portions by performing an image analysis on the captured images included in the inspection results data;
a generation unit that performs time-series comparison on the inspection results data at the multiple points of time, and generating the maintenance plan based on the result of the time-series comparison; and
an output unit that outputs the maintenance plan generated by the generation unit, and
wherein the inspection result data includes the detection result of the damaged portion in addition to the captured image and the positional information generated by using the image analysis result using the captured image analysis unit.

2. The maintenance plan drafting support system according to claim 1,
wherein the generation unit predicts a progression of damage based on a degree of the damage changing with time for a predetermined past period, which is included in the inspection target portion, and a most recent inspection result data of the damage from the inspection results data at the multiple past points of time, and generates the maintenance plan based on the prediction result of the progression of the damage.

3. The maintenance plan drafting support system according to claim 2,
wherein the generation unit gives a high maintenance priority to a portion in which it is predicted that the progression of the damage is to be rapid.

4. The maintenance plan drafting support system according to claim 2, further comprising:
a preferential inspection portion information acquisition unit that acquires preferential inspection portion information indicating a preferential inspection portion of the structural object to which a high maintenance priority is given,
wherein the generation unit estimates a progression direction and a progression rate of the damage based on the prediction result of the progression of the damage, and generates the maintenance plan based on a relationship between the estimation result of the progression direction and the progression rate of the damage and the preferential inspection portion in addition to the result of the time-series comparison.

5. The maintenance plan drafting support system according to claim 3, further comprising:
a preferential inspection portion information acquisition unit that acquires preferential inspection portion information indicating a preferential inspection portion of the structural object to which a high maintenance priority is given,
wherein the generation unit estimates a progression direction and a progression rate of the damage based on the prediction result of the progression of the damage, and generates the maintenance plan based on a relationship between the estimation result of the progression direction and the progression rate of the damage and the preferential inspection portion in addition to the result of the time-series comparison.

6. The maintenance plan drafting support system according to claim 4, further comprising:
a preferential inspection portion specification unit that generates the preferential inspection portion information by specifying the preferential inspection portion of the inspection target portions of the structural object based on at least one information of information regarding importance of the inspection target portion in terms of structure, design information of the inspection target portion, or environment information in which the inspection target portion is positioned.

7. The maintenance plan drafting support system according to claim 5, further comprising:
a preferential inspection portion specification unit that generates the preferential inspection portion information by specifying the preferential inspection portion of the inspection target portions of the structural object based on at least one information of information regarding importance of the inspection target portion in terms of structure, design information of the inspection target portion, or environment information in which the inspection target portion is positioned.

8. The maintenance plan drafting support system according to claim 1, further comprising:
a plan input unit that receives an input of at least one plan of an inspection plan or a repair plan of the structural object,
wherein the generation unit generates the maintenance plan based on the plan received by the plan input unit in addition to the result of the time-series comparison.

9. The maintenance plan drafting support system according to claim 2, further comprising:
a plan input unit that receives an input of at least one plan of an inspection plan or a repair plan of the structural object,
wherein the generation unit generates the maintenance plan based on the plan received by the plan input unit in addition to the result of the time-series comparison.

10. The maintenance plan drafting support system according to claim 8,
wherein the plan input unit receives an input of an inspection timing determined for the structural object, and
the generation unit matches an inspection or repair timing of the structural object with the inspection timing based on the maintenance plan.

11. The maintenance plan drafting support system according to claim 9,
wherein the plan input unit receives an input of an inspection timing determined for the structural object, and
the generation unit matches an inspection or repair timing of the structural object with the inspection timing based on the maintenance plan.

12. The maintenance plan drafting support system according to claim 1,
wherein the generation unit performs cost estimation of the maintenance plan, and generates the maintenance plan based on the result of the cost estimation in addition to the result of the time-series comparison.

13. The maintenance plan drafting support system according to unit that claim 2,
wherein the generation unit performs cost estimation of the maintenance plan, and generates the maintenance plan based on the result of the cost estimation in addition to the result of the time-series comparison.

14. The maintenance plan drafting support system according to claim 1, further comprising:
a repair result input unit that receives inputs of repair results indicating results acquired by repairing the inspection target portions at the multiple past points of time,
wherein the generation unit performs the time-series comparison on the repair results at the multiple points of time, and generates the maintenance plan.

15. The maintenance plan drafting support system according to claim 1, further comprising:
a repair result input unit that receives inputs of repair results indicating results acquired by repairing the inspection target portions at the multiple past points of time,
wherein the generation unit performs the time-series comparison on the repair results at the multiple points of time, and generates the maintenance plan.

16. The maintenance plan drafting support system according to claim 1,
wherein the generation unit changes a time taken to perform next maintenance or changes an inspection item in the next maintenance in a case where an evaluation value of the structural object in a most recent inspection result data is equal to or greater than a threshold value.

17. The maintenance plan drafting support system according to claim 2,
wherein the generation unit changes a time taken to perform next maintenance or changes an inspection item in the next maintenance in a case where an evaluation value of the structural object in a most recent inspection result data is equal to or greater than a threshold value.

18. The maintenance plan drafting support system according to claim 1,
wherein the generation unit generates the maintenance plan at predetermined time intervals.

19. A maintenance plan drafting support method for supporting drafting of a maintenance plan of a structural object, the method comprising:
receiving inputs of inspection results data at multiple past points of time which include image information items including captured images of inspection target portions of the structural object and positional information items of the inspection target portions;
detecting an damaged portion from images of inspection target portions by performing an image analysis on the captured images included in the inspection results data;
performing time-series comparison on the inspection results data at the multiple points of time, and generating the maintenance plan based on the result of the time-series comparison;
outputting the generated maintenance plan, and
generating inspection result data includes the detection result of the damaged portion in addition to the captured image and the positional information by using the image analysis result.

20. A non-transitory computer readable recording medium storing a maintenance plan drafting support program for supporting drafting of a maintenance plan of a structural object, which causes a computer to realize:
an inspection result inputting function of receiving inputs of inspection results data at multiple past points of time which include image information items including captured images of inspection target portions of the structural object and positional information items of the inspection target portions;
a captured image analysis function of detecting an damaged portion from images of inspection target portions by performing an image analysis on the captured images included in the inspection results data;
a generation function of performing time-series comparison on the inspection results data at the multiple points of time, and generating the maintenance plan based on the result of the time-series comparison;
an outputting function of outputting the generated maintenance plan; and
a generating function of inspection result data includes the detection result of the damaged portion in addition to the captured image and the positional information by using the image analysis result.
